(19) United States
(12) Patent Application Publication
(10) Pub. No.: US 2010/0186831 A1
(43) Pub. Date: Jul. 29, 2010

(54) Thermostatic valve for mounting between a fuel tank and a combustion engine and related fuel circulation circuit

(76) Inventors: Jean-Michel Roman, Perthes En Gatinais (FR); Lionel Mabboux, Sainte Genevieve Des Bois (FR)

Correspondence Address: DOWELL & DOWELL P.C., 103 Oronoco St., Suite 220, Alexandria, VA, 22314, US

(21) Appl. No.: 12/310,550

(22) PCT Filed: Aug. 29, 2007
(86) PCT No.: PCT/FR2007/001410

§ 371 Date: Feb. 27, 2009

(30) Foreign Application Priority Data
Aug. 30, 2006 (FR) 06/07,629

(51) Int. Cl. F16K 17/38

(52) U.S. Cl. 137/468

(57) ABSTRACT

The valve (10) comprises a hollow body (12) for receiving a thermostatic member (50) that comprises a cup (501) for receiving an expandable wax and a slider (503) capable of displacement due to the wax expansion, a first pair of connectors (141, 142) defining a first fuel path and a second pair of connectors (161, 162) defining a second fuel path, the hollow body (12) further defining a short-circuit (60) between the rust and second fuel paths. The valve further includes an actuator (40) that can be operated from the outside of the body (12), wherein said actuator (40) is capable of moving the slider (503) from a short-circuit (60) free-passage position to a short-circuit closed position, and of maintaining the slider in said closed position.

The present invention relates to a thermostatic valve intended to be interposed between a fuel tank and a combustion engine and to a fuel circulation circuit comprising at least one such thermostatic valve.

A valve of the aforementioned type, which comprises a hollow body in which there is mounted a thermostatic element, is known. This thermostatic element is usually made up of a cup, in which expanding wax is stored, while a piston and a spool are able to move relative to this cup under the effect of the expanding of this wax.

This valve further comprises a first pair of coupling members which in use are connected to hoses. A first coupling member receives fuel from a tank, which is more particularly, although not exclusively, diesel fuel. This diesel fuel then flows around the aforementioned cup and is then sent to a combustion engine, via another coupling member.

There is also a second pair of coupling members, again connected to hoses, one of which receives fuel returning from the combustion engine and which flows close to the spool of the thermostatic element before returning to the tank, via the other coupling member. In this way, these two pairs of coupling members define first and second fuel paths connecting the tank and the engine in both directions.

The thermostatic valve also delimits a short circuit, placing these two fuel paths selectively in communication. This short circuit is therefore delimited by the facing walls of, on the one hand, the body of the valve and, on the other hand, of the spool and of the cup of the thermostatic element.

The flow rate of fuel capable of flowing through this short circuit is dependent on the temperature of the fuel which itself influences the position of the spool.

Thus, when the temperature is low, particularly upon engine start-up, the spool offers maximum passage to the short circuit, which means that a substantial fraction, for example close to 90%, of the fuel is recirculated to the engine. In other words, only a marginal fraction of this fuel is returned directly to tank.

As the temperature gradually increases, for example upwards of 15° C., the spool moves axially, under the effect of the expanding of the wax, in order little by little to block off the short circuit. As a result, the fraction of fuel that is recirculated to the engine reduces during this rise in temperature.

Finally, when the temperature exceeds a preset value, for example close to 30° C., the spool completely blocks off the short circuit so that practically all of the fuel returning from the engine is returned to tank. Furthermore, if the temperature drops again, the wax of the thermostatic element contracts, while the piston and spool are pushed back by a return spring so that fuel is once again able to flow through the short circuit.

Under certain circumstances it may be advantageous, or even necessary, to block off the short circuit, even at not very high temperatures at which the expanding of the wax would not allow the spool naturally to adopt its position in which it blocks off this short circuit. Thus, in the case of a diesel engine, this operation allows the fuel to be forced to return to tank so that it can be degassed, for example following a fuel filter change.

This being the case, the invention aims to provide a thermostatic valve that can be brought simply, quickly and reliably into its position in which it blocks off the short circuit, even when the temperature is not particularly high.

To this end, the subject of the invention is a thermostatic valve intended to be interposed between a fuel tank and a combustion engine, this valve comprising a hollow body in which there is housed a thermostatic element which comprises a cup containing an expanding wax, and a spool able to move with respect to the cup under the effect of the expanding of the wax, this valve further comprising a first pair of coupling members defining a first fuel path from the tank to the engine, extending near the cup, and a second pair of coupling members defining a second fuel path from the engine to the tank, extending near the spool, the hollow body further defining a short circuit between the first and second fuel paths, the spool being able to move between a position in which the fluid passes freely through the short circuit and a position in which this short circuit is blocked off, characterized in that it further comprises an actuating member that can be operated from outside the body, this actuating member being able to move the spool from its position in which there is free passage through the short circuit to its position in which the short circuit is blocked off, and then keep this spool in this blocking-off position.

According to other features of the invention:
the actuating member can move between a rest position in which it has no influence on the position of the spool and an actuating position in which it keeps the spool in its blocking-off position;
the actuating member comprises means of quick locking relative to the body;
the actuating member comprises a stem able to bear against the thermostatic element so as to push it back, and at least one quick-lock radial tab that can be locked with respect to a wall of the body in the actuating position of the actuating member;
in its movement from its rest position to its actuating position, the actuating member is able to move first of all with an axial movement and then with a rotational movement about its main axis;
during said axial movement of the actuating member, the or each tab slides in at least one cutout formed in a shaft of the body, the or each tab being locked with respect to at least one recess provided near the or each cutout, at the end of the pivoting movement of the actuating member;
when the actuating member is in the rest position, the or each tab rests against a bearing surface bordering a corresponding cutout;
the stem of the actuating member is able to slide in a passage formed in the shaft of the body, this stem having an operating end that is accessible from outside this hollow body;
said operating end is cut with a slot, particularly a diametral one, able to collaborate with an operating tool such as a screwdriver.

A further subject of the invention is a fuel circulation circuit connecting a tank for this fuel and a combustion engine that runs on this fuel, this circuit comprising at least one thermostatic valve as defined hereinabove.

The invention will be better understood from reading the description which will follow, which is given solely by way of nonlimiting example and made with reference to the attached drawings, in which:

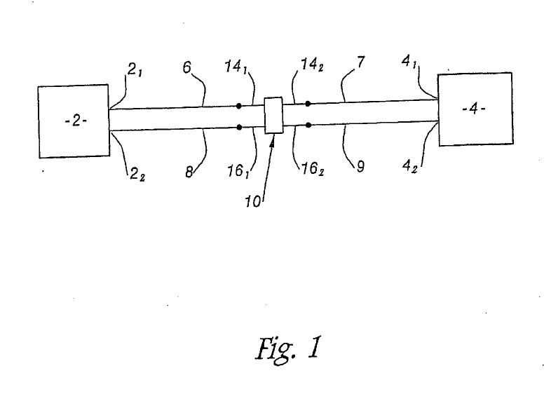

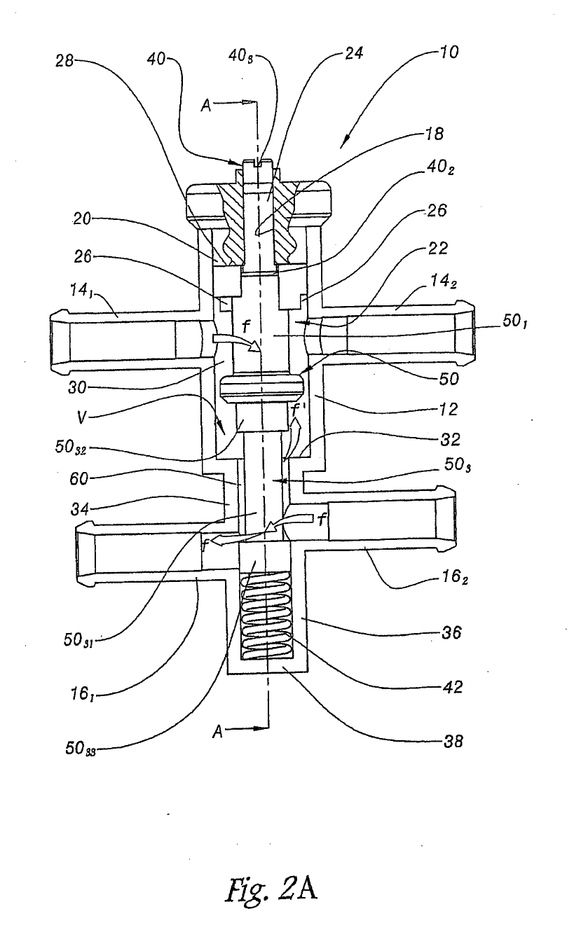

FIG. 1 is a schematic depiction of a fuel circulation circuit equipped with a thermostatic valve according to the invention;

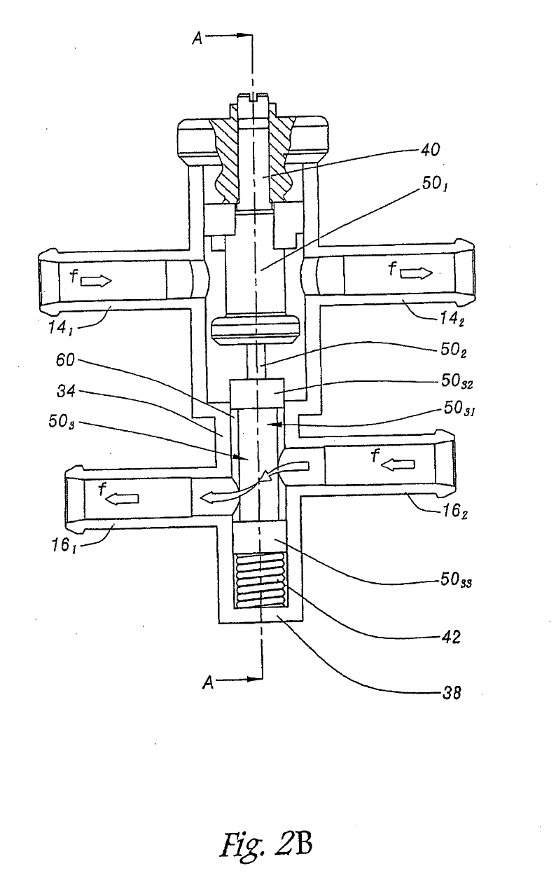

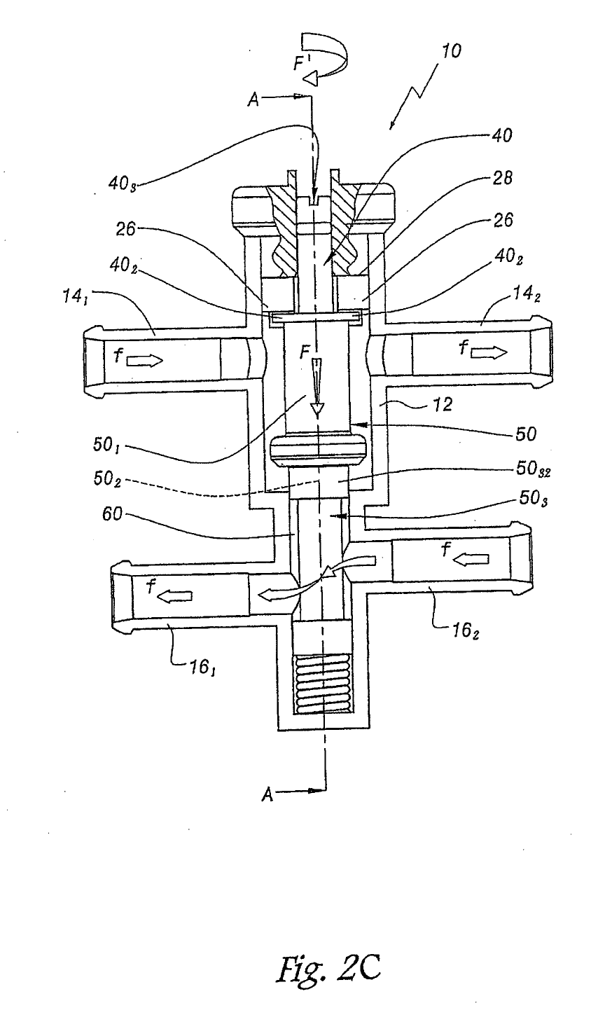

FIGS. 2A, 2B and 2C are front-on views illustrating three different positions of the thermostatic valve according to the invention; and

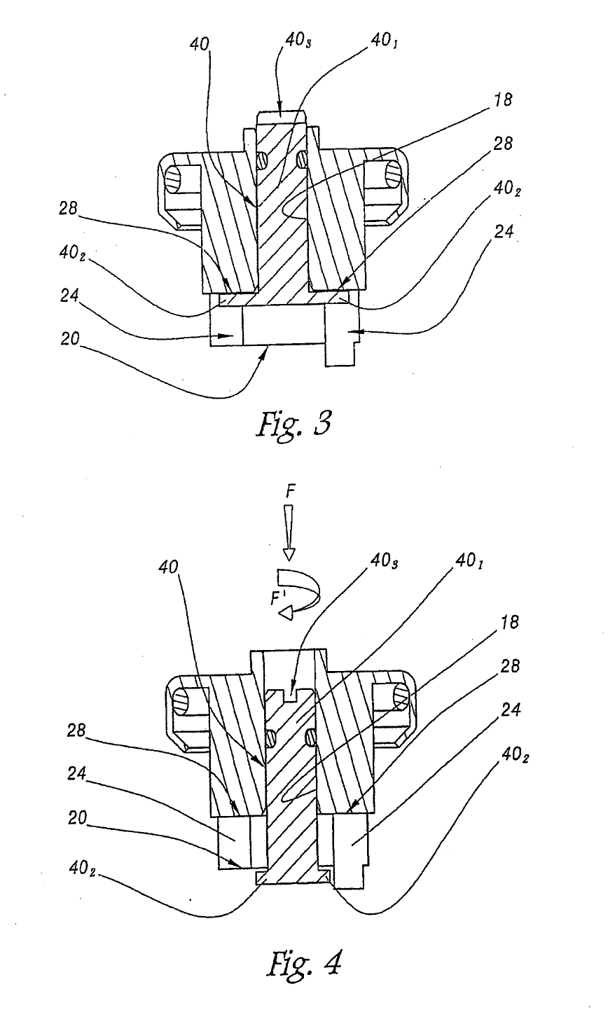

FIGS. 3 and 4 are views in section, more specifically illustrating two positions of a member for actuating the valve of the preceding figures.

FIG. 1 schematically illustrates a fuel tank 2 and a combustion engine 4 both belonging to a motor vehicle which has not been depicted. In the example illustrated, this is a diesel engine, supplied with diesel fuel. However, the invention can be applied to other types of fuel, particularly of the gasoline type.

There is also a fuel circulation circuit connecting this tank 2 and this engine 4. This circuit first of all comprises a thermostatic valve according to the invention, denoted overall by the reference 10, and four hoses 6, 7, 8 and 9. These hoses connect the various inlets and outlets of the valve 10 to the tank and to the engine respectively, as will be explained in greater detail in that which follows.

FIGS. 2A to 2C more specifically illustrate this thermostatic valve 10 which comprises a hollow body 12 defining an interior volume V opening into four ducts, themselves placed in communication with the aforementioned hoses 6 to 9.

First of all there is a first pair of ducts 14₁, 14₂ which are connected to the hoses 6 and 7. These ducts 14₁ and 14₂ are thus placed in communication, on the one hand, with a fuel outlet 2₁ from the tank 2 and, on the other hand, with a fuel inlet 4₁ into the engine 4.

In addition, a second pair of ducts 16₁ and 16₂ extends from the hollow body 12, toward the lower part thereof in the figures. The duct 16₁ is in communication, via the hose 8, with a fuel inlet 2₂ into the tank 2, whereas the duct 16₂ is placed in communication, via the hose 9, with an outlet 4₂ for fuel from the engine 4.

The upper part, in the figures, of the hollow body 4 is cut with an open-ended passage 18 (see FIG. 3 in particular), of substantially cylindrical shape, at the lower end of which there extends a shaft 20, the walls of which define an intermediate chamber 22. These walls are first of all cut with two diametral cutouts and with two diametrically opposed recesses 26. The upper walls of each cutout define a corresponding bearing surface 28.

Below the shaft 20, the hollow body 12 delimits a main chamber 30 into which the ducts 14₁ and 14₂ open. At its bottom end, this chamber 30 is bordered by a reentrant shoulder 32 which forms a restriction 34 into which the ducts 16₁ and 16₂ open. Below the region where this restriction and these two ducts meet, there is, finally, a housing 36 closed by an end wall 38.

As illustrated by FIG. 3 in particular, the thermostatic valve 10 is also equipped with an actuating member 40 which has a stem 40₁ extending into the passage 18. At its inner end, namely toward the bottom of FIG. 3, the stem 40₁ is extended by two diametral tabs 40₂, each of which is able to bear against a corresponding bearing surface 28. At its outer end, namely positioned toward the top of FIG. 3, the stem 40₁ is cut with a slot 40₃ able to collaborate with a tool, not depicted, particularly a screwdriver.

The actuating member 40 bears against the cup 50₁ of a thermostatic element 50 of a type known per se. The latter also comprises a piston 50₂ visible in FIG. 2B in particular and which can move relative to the cup 50₁ along an axis A, in this instance a vertical axis, under the effect of the expanding of the wax contained in this cup.

This piston 50₂ is secured to a cylindrical spool 50₃ which has a central stem 50₃₁ and two end pieces 50₃₂ and 50₃₃. The latter have a diameter greater than that of the stem 50₃₁, namely a diameter close to the diameter of the restriction 34. Finally, a return spring 42 is interposed between the end wall 38 of the body 12 and the spool 50₃ end piece 50₃₃ face opposite.

The way in which the thermostatic valve 10, described hereinabove, works, will now be explained in that which follows.

FIG. 2A illustrates one working of this valve 10, when fuel at relatively low temperature, particularly at a temperature of below 15° C., flows in the interior volume V via the ducts 14₁, 14₂ and 16₁ and 16₂. Under these circumstances, the wax contained in the cup 50₁ has not expanded, which means that the spool 50₃ is positioned near the cup 50₁. The tabs 40₂ of the actuating member 40 therefore bear against the bearing surfaces 28. The flow of fuel through these ducts, and near the cup 50₁ and the spool 50₃, is shown by the arrows f.

The walls of the thin stem 50₃₁ face the restriction 34, so as to define an annular space thus creating a short circuit 60. This short circuit places the first pair of ducts 14₁ and 14₂ in fluidic communication with the second pair of ducts 16₁ and 16₂. As a result, a substantial fraction of the fuel from the engine 4, via the duct 16₂, can be returned to this engine, via the short circuit 60 and the duct 14₂, in the direction of the arrows f′.

Then, as the temperature of the fuel flowing through the valve gradually increases, the wax contained in the cup 50₁ has a tendency to expand, thus pushing the piston 50₂ and the spool 50₃ back downward in the conventional way. This movement leads to a gradual reduction in the flow rate of fuel returned to the engine 4, from the duct 16₂ to the duct 14₂, via the short circuit 60. This intermediate phase in the operation of the valve 10 is not depicted in the figures, given that it is of the type known per se.

Finally, when the temperature exceeds a preset value, for example close to 30° C., the end piece 50₃₂ of the spool 50₃ comes into contact with the walls of the restriction 34, under the effect of the expanding of the wax. As a result, given that the respective diameters of this end piece and of this restriction are similar, the short circuit 60 becomes substantially blocked off as illustrated in FIG. 2B.

Under these conditions, any significant return of fuel to the engine is prevented. Thus, all of the fuel flows, on the one hand, from the tank 2 to the engine 4 via the ducts 14₁ and 14₂ and, on the other hand, from the engine 4 to the tank 2 via the ducts 16₂ and 16₁ (arrows f).

Assuming that the spool 50₃ is in its position in which it blocks off the short circuit 60, which position is illustrated in FIG. 2B, a reduction in fuel temperature causes the wax contained in the cup 50₁ to contract. The spring 42 then returns the piston 50₂ and the spool 50₃ upward, so as once again to allow fuel to flow through the short circuit 60. This phenomenon, again of a type known per se, is not illustrated in the figures either.

In the phases of operation of the valve 10 which are illustrated with reference to the preceding figures, the actuating member 40 is in its rest position, that is to say has no influence on the position of the thermostatic element 50. Under certain circumstances it may be advantageous to bring the valve into its position in which it blocks off the short circuit 60, this position being illustrated in FIG. 2B, even though the expansion of the wax does not cause the spool 50₃ to move. As mentioned previously, this operation means that the fuel can be forced to return to tank, for example so that it can be degassed, following a diesel engine fuel filter change.

Operation of the actuating member 40, starting from the position in which there is free passage through the short circuit 60, which position is depicted in FIG. 2A, will now be described. What is involved firstly is to operate the actuating member 40, for example using a tool, not depicted, that engages in the slot 40₃. This action of an axial type first of all causes the actuating member 40 to move translationally downward, as embodied by the arrow F in FIGS. 2C and 4.

Under these conditions, the tabs 40₂ of the actuating member 40 move away from the bearing surfaces 28, while any rotational movement of the actuating member is prevented by the presence of the side walls of the cutouts 24. When the tabs 40₂ arrive facing the recesses 26, the aforementioned axial movement of the actuating member 40 has caused a corresponding movement of the spool, which means that its end piece 50₃₂ blocks off the short circuit 60 in a similar way to that which was described with reference to FIG. 2B. In order to keep this spool in this position, what is finally involved is to cause the actuating member 40 to pivot about its main axis in the direction of the arrow F′, so as to lock the tabs 40₂ against the recesses 26.

FIG. 2C illustrates the thermostatic valve 10 on completion of this operation of the actuating member. The latter is in its actuating position because it is positioned near the recesses 26, whereas the spool 50₃ is in its position in which it blocks off the short circuit 60. It will be noted that this position is reached even without an expansion of the wax contained in the cup 50₁, because the piston 50₂ has not been deployed.

If the actuating member 40 is to be unlocked, all that is required is to use an operating tool once again so as first of all to cause this actuating member 40 to pivot so that the tabs 40₂ no longer engage with the recesses 26. Next, the presence of the spring 42 returns this actuating member 40 to its rest position of FIGS. 2A and 2B, in which position the tabs 40₂ butt against the bearing surfaces 28.

1.-10. (canceled)

11. A thermostatic valve (10) intended to be interposed between a fuel tank (2) and a combustion engine (4), this valve (10) comprising a hollow body (12) in which there is housed a thermostatic element (50) which comprises a cup (50₁) containing an expanding wax, and a spool (50₃) able to move with respect to the cup under the effect of the expanding of the wax, this valve further comprising a first pair of coupling members (14₁, 14₂) defining a first fuel path from the tank (2) to the engine (4), extending near the cup (50₁), and a second pair of coupling members (16₁, 16₂) defining a second fuel path from the engine (4) to the tank (2), extending near the spool (50₃), the hollow body (12) further defining a short circuit (60) between the first and second fuel paths, the spool (50₃) being able to move between a position in which the fluid passes freely through the short circuit (60) and a position in which this short circuit (60) is blocked off, wherein it further comprises-an actuating member (40) that can be operated from outside the body (12), this actuating member (40) being able to move the spool (50₃) from its position in which there is free passage through the short circuit to its position in which the short circuit is blocked off, and then keep this spool in this blocking-off position.

12. The thermostatic valve as claimed in claim 11, wherein the actuating member (40) can move between a rest position in which it has no influence on the position of the spool (50₃) and an actuating position in which it keeps the spool (50₃) in its blocking-off position.

13. The thermostatic valve as claimed in claim 11, wherein the actuating member (40) comprises means (40₂) of quick locking relative to the body (12).

14. The thermostatic valve as claimed in claim 13, wherein the actuating member (40) comprises a stem (40₁) able to bear against the thermostatic element (50) so as to push it back, and at least one quick-lock radial tab (40₂) that can be locked with respect to a wall of the body (12) in the actuating position of the actuating member (40).

15. The thermostatic valve as claimed in claim 13, wherein, in its movement from its rest position to its actuating position, the actuating member (40) is able to move first of all with an axial movement and then with a rotational movement about its main axis.

16. The thermostatic valve as claimed in claim 14, wherein, during said axial movement of the actuating member (40), the or each tab (40₂) slides in at least one cutout (24) formed in a shaft (20) of the body (12), the or each tab (40₂) being locked with respect to at least one recess (26) provided near the or each cutout, at the end of the pivoting movement of the actuating member (40).

17. The thermostatic valve as claimed in claim 16, wherein, when the actuating member (40) is in the rest position, the or each tab (40₂) rests against a bearing surface (28) bordering a corresponding cutout (24).

18. The thermostatic valve as claimed in claim 16, wherein the stem (40₁) of the actuating member (40) is able to slide in a passage (18) formed in the shaft (20) of the body (12), this stem having an operating end that is accessible from outside this hollow body (12).

19. The thermostatic valve as claimed in claim 18, wherein said operating end is cut with a slot (40₃), particularly a diametral one, able to collaborate with an operating tool such as a screwdriver.

20. A fuel circulation circuit connecting a tank (2) for this fuel and a combustion engine (4) that runs on this fuel, this circuit (6, 7, 8, 9, 10) comprising at least one thermostatic valve (10) in accordance with claim 11.
